(19) United States
(12) Patent Application Publication
(10) Pub. No.: US 2020/0359664 A1
(43) Pub. Date: Nov. 19, 2020

(54) Delicious low-glycemic index formula rice and its application

(71) Applicant: Jiangnan University, Wuxi (CN)

(72) Inventors: Yongfu LI, Wuxi (CN); Jinrong HUANG, Wuxi (CN); Feng SHI, Wuxi (CN); Zhengxing CHEN, Wuxi (CN)

(21) Appl. No.: 16/984,247

(22) Filed: Aug. 4, 2020

(30) Foreign Application Priority Data
Oct. 25, 2019 (CN) 2019110211567
Mar. 5, 2020 (CN) 2020101461890
Mar. 5, 2020 (CN) 2020101461975

(51) Int. Cl. A23L 7/196; A23L 11/00; A23B 9/02; A23L 5/10; A23B 9/00; A23B 9/10; A23L 33/00

(52) U.S. Cl. CPC A23L 7/1965; A23L 11/05; A23B 9/02; A23V 2002/00; A23B 9/005; A23B 9/10; A23L 33/40; A23L 5/13

(57) ABSTRACT

The disclosure discloses delicious low-glycemic index formula rice and its application, and belongs to the technical field of food. The low-GI formula rice comprises low-GI rice, rice and coarse cereals; the mass ratio of the low-GI rice to the rice to the coarse cereals is (3-5):(0-2):5; and the coarse cereals comprise 15-25 parts of mung beans, 8-15 parts of black rice, 10-15 parts of oat milled rice with embryo, 5-10 parts of black sticky rice and 3-10 parts of tartary buckwheat. Exogenous addition is avoided, all used raw materials are natural, through reasonable matching of the low-GI rice, the rice and the coarse cereals, the content of GI value can be neutralized, furthermore, an effect of improving the viscosity and elasticity of cooked rice processed from the low-GI formula rice can be improved, mouthfeel can also be enriched, and the quality and mouthfeel of the cooked rice processed from the low-GI formula rice are slightly different from those of cooked rice; and the GI value of the product is less than 55, so that diabetic patients can eat the high-taste-value low-GI formula rice as staple food at ease.

### TECHNICAL FIELD

The disclosure relates to delicious low-glycemic index formula rice and its application, and belongs to the technical field of food.

### BACKGROUND

Rice serving as staple food has a long history in China, and a largest number of people eat rice. In different years, the ways of eating rice are different, and the change history from initial brown rice to polished rice and then to brown rice is also the change history of cognition of human beings on staple food nutrition and health effects. In the ancient times, people cooked different grains together, and called the cooked grains as fragrant rice. It can be seen that old ancestors knew that different grains and coarse cereals are put together to be cooked, and the mouthfeel and the fragrance of the cooked grains and coarse cereals are obviously different from those of single rice. However, at present, people also mix and cook various rice and coarse cereals together for richer mouthfeel and also for a healthier diet mode. How well the staple food is eaten after the satiety problem is solved? How healthy a staple food is eaten? People pay more attention to these problems. Healthy people always pay attention to the problems of high GI (Glycemic Index) and high starch of rice serving as staple food, particularly diabetes patients pay most attention to the problems, and the rice becomes a contraindication of staple food of the diabetes patients. Meanwhile, the health problems of insufficient dietary fiber, vitamin deficiency, obesity, colon cancer and the like are easily caused by taking rice as staple food. Existing low-GI staple food mainly comprises flour products, and low-GI staple food capable of completely replacing rice is lacked in the market, so that type-2 diabetes patients cannot eat rice at ease. Due to the fact that rice is good in mouthfeel, high in consumer acceptance and high in dependence, and coarse cereals are difficult to cook, poor in mouthfeel and the like due to the fact that grain skin structures of the coarse cereals are compact, staple food of the coarse cereals is limited. At present, the coarse cereals are modified through modes of extrusion, puffing, recombination and the like in the market, and the shapes and structures of the coarse cereals and the rice are changed; or the coarse cereals and the rice are mixed and crushed together and then granulated so as to achieve the purpose of reducing the GI value; coarse cereal cooked rice prepared from the rice and the coarse cereals cannot meet the requirement for the low GI due to the high rice content; and extracts capable of inhibiting the activity of α-amylase are also added to some products so as to achieve the purpose of reducing the GI of food. The shape and structure of the modified and granulated coarse cereals are destroyed, the GI of the coarse cereals is easily increased, moreover, the modified and granulated coarse cereals have defects of poor mouthfeel and the like and cannot be widely accepted by consumers, and recombination or exogenous addition is resisted by people pursuing the form of natural staple food; the coarse cereal cooked rice prepared by compounding the coarse cereals and the rice is rough in mouthfeel, high in hardness, poor in fusion of the coarse cereals and the rice and poor in palatability, the use amount and ratio of the coarse cereals are limited, and the requirement of low GI cannot be met.

GI of food is highly positively correlated with postprandial blood glucose response, food can be divided into high-GI food, medium-GI food and low-GI food according to the blood glucose rising amplitude at a certain time after the food is ingested, the food with GI larger than 70 is the high-GI food, the food with GI larger than 55 and smaller than or equal to 70 is the medium-GI food, and the food with GI smaller than or equal to 55 is the low-GI food. After entering the intestinal tract, the high-GI food is fast in starch hydrolysis, fast in digestion, fast in absorption, and high in postprandial blood glucose response, and can easily cause chronic diseases such as obesity and hyperglycemia after being eaten for a long time. The low-GI food is slow in digestion of starch, slow in glucose release, low in postprandial blood glucose response and correspondingly low in insulin required by in-vivo metabolism, so that severe fluctuation of human blood glucose after eating is avoided, and the low-GI food has an obvious effect of preventing blood glucose fluctuation and is beneficial to controlling the human blood glucose within a reasonable range.

Besides, the low-GI food containing coarse cereals has stronger satiety, which is related to higher dietary fiber content in the coarse cereals, and cooked rice processed from the low-GI formula rice is more hunger-resistant because the cooked rice processed from the low-GI formula rice is lower in starch digestion and release speed, longer in continuous energy supply time, capable of reducing fat formation and beneficial to weight control, but the high-GI food is opposite in effect. A large number of researches show that long-term eating of the low-GI food has obvious effects of relieving symptoms of hyperglycemia and hypertension, controlling body weight and the like.

On the premise of ensuring good mouthfeel, compounding of rice with medium-GI coarse cereals and low-GI coarse cereals cannot meet the requirement of low GI, in the team, GI of the coarse cereal cooked rice is reduced by increasing the ratio of the low-GI coarse cereals, but when the ratio of single coarse cereal exceeds a certain ratio, the mouthfeel, color and flavor of the coarse cereal cooked rice can be obviously reduced, and the acceptability of consumers is low. Researches of the team find that although the low-GI rice has the problems of poor cooking mouthfeel and low acceptability of consumers, the cooking characteristics of different low-GI rice are greatly different, through testing of a domestic common low-GI rice system and sensory evaluation on the low-GI rice system, it is found that the mouthfeel and flavor of the low-GI formula rice can be remarkably improved by compounding specific varieties of low-GI rice, rice and coarse cereals, part of the coarse cereals are pretreated, proper coarse cereal verities are screened, the ratio of the coarse cereals in coarse cereal rice can be increased to 50% by using multiple coarse cereals in cooperation with the rice and the low-GI rice, the low-GI requirement of the coarse cereal rice is met, good mouthfeel of cooked rice is also ensured, and the high-taste-value low-GI formula rice is widely welcomed by consumers.

### SUMMARY

According to the disclosure, low-GI rice, rice and various coarse cereals with low GI value are scientifically compounded to prepare high-taste-value low-GI formula rice, the high-taste-value low-GI formula rice can be easily cooked like rice, has similar mouthfeel to the rice, and has richer nutrition compared to the rice. After the high-taste-value low-GI formula rice is cooked under normal pressure, cooked rice processed from the high-taste-value low-GI formula rice is relatively high in dietary fiber content, relatively high in phytochemical content and relatively low in postprandial blood glucose response, and is more suitable for being used as staple food for crowds with hyperglycemia, so that the problem that the crowds with hyperglycemia want to eat the staple food but are afraid to eat is solved, and the life quality of the crowds with hyperglycemia is improved. The high-taste-value low-GI formula rice contains 25% or more of low-GI rice, less than 25% of rice and 50% of coarse cereals, and the coarse cereals contain low-GI foods such as beans and tartary buckwheat, wherein oat milled rice with embryo is rich in β-glucan, and is one of the most suitable foods recognized in the world to be eaten by people with hyperglycemia. The low-GI formula rice prepared by the disclosure not only provides a better choice for staple food of people suffering from type-2 diabetes, but also can be used as staple food for normal people due to good mouthfeel and rich nutrition.

According to the disclosure, the problems of high GI, high starch, low dietary fiber content and the like of cooked rice eaten by current families in daily life are solved, meanwhile, nutrients such as protein and phytochemicals in the cooked rice are added, and nutrition of staple food is balanced. According to the technical scheme, suitable low-GI rice and rice are selected to be matched, and meanwhile, suitable coarse cereals are selected to be compounded with the low-GI rice and the rice. The coarse cereals, the low-GI rice and the rice are uniformly mixed according to different ratios to obtain the high-taste-value low-GI formula rice. The high-taste-value low-GI formula rice does not need to be soaked, is washed conventionally and is added with water at a certain ratio. The rice is cooked in an electric cooker under normal pressure for 30-40 min, and then the cooked rice is insulated for 20-30 min so as to be eaten as staple food.

A first purpose of the disclosure is to provide high-taste-value low-GI formula rice, and the low-GI formula rice comprises low-GI rice, rice and coarse cereals; the mass ratio of the low-GI rice to the rice to the coarse cereals is (1-5):(0-4): 5; the mass ratio of the low-GI rice to the rice to the coarse cereals is (1-4):(1-4): 5, or the high-taste-value low-GI formula rice comprises the low-GI rice and the coarse cereals; and the mass ratio of the low-GI rice to the coarse cereals is 1:(0.8-1.2).

In an embodiment of the disclosure, the hardness of the low-GI rice is 2000-2700 g, the viscosity is 20-25, and the elasticity is 0.6-0.8.

In an embodiment of the disclosure, the coarse cereals comprise one or more of mung beams, black rice, oat milled rice with embryo, black sticky rice and tartary buckwheat.

In an embodiment of the disclosure, the coarse cereals comprise 15-25 parts of the mung beans, 8-15 parts of the black rice, 10-15 parts of the oat milled rice with embryo, 5-10 parts of the black sticky rice and 3-10 parts of the tartary buckwheat.

In an embodiment of the disclosure, the mung beans are obtained by high-temperature fluidization treatment, and fluidization conditions are as follows: the temperature is 165-180° C., and the time is 30-60 s.

In an embodiment of the disclosure, the black rice is obtained by high-temperature fluidization treatment, and fluidization conditions are as follows: the temperature is 145-160° C. and the time is 30-60 s.

A second purpose of the disclosure is to provide application of the high-taste-value low-GI formula rice in food.

A third purpose of the disclosure is to provide application of the high-taste-value low-GI formula rice in preparation of food for prevention or auxiliary improvement of diabetes.

A fourth purpose of the disclosure is to provide a preparation method of cooked rice processed from the high-taste-value low-GI formula rice. The method comprises: taking the low-GI formula rice as a raw material, placing the low-GI formula rice in a household electric cooker, washing the rice, then adding a certain amount of water, cooking the rice for 30-50 min under normal pressure, and insulating the cooked rice for 20-30 min for eating.

A fifth purpose of the disclosure is to provide a preparation method of instant cooked rice processed from the high-taste-value low-GI formula rice. The preparation method is characterized by comprising: taking the low-GI formula rice as a raw material, washing the rice, then adding water for soaking for 40-60 min, cooking the rice for 30-40 min under normal pressure, adding edible oil, packaging the cooked rice into a food-grade packaging material capable of sterilizing under high pressure, performing sterilization for 20-30 min under normal pressure, performing cooling, and then taking out the cooked rice so as to obtain the instant cooked rice processed from the high-taste-value low-GI formula rice.

The disclosure has the following beneficial effects:

(1) In the disclosure, three different varieties of low-GI rice are screened out, and are good in mouthfeel. After the low-GI rice is compounded and cooked with the rice and the coarse cereals, the quality is good, the mouthfeel is also good, through sensory evaluation, the taste score is between 55-56 (the full score is 60), and difference between the high-taste-value low-GI rice and rice is small.

(2) The coarse cereals of the disclosure are unprocessed food grains, and are not treated by processes such as crushing, extrusion, puffing and recombination. After part of the coarse cereals are treated by a high-temperature fluidization technology, the coarse cereals do not need to be soaked in advance, and the coarse cereals can be cooked with the rice and the low-GI rice under normal pressure.

(3) The ratio of the coarse cereals is changed along with the variety of the low-GI rice, and the ratio of the coarse cereals in a formula is 50%; and by matching of the low-GI rice and the coarse cereals, defects of high hardness, insufficient viscosity and the like of two kinds of raw materials are overcome, and a synergistic effect is also achieved in the aspects of inhibition of starch retrogradation of the low-GI rice and retaining of coarse cereal fragrance; or the low-GI rice, the rice and the coarse cereals interact, and supplement one another, and a synergistic effect is achieved on the quality and mouthfeel of the coarse cereals.

(4) Any exogenous addition is avoided, all raw materials are natural, cooking performance is improved by matching of the raw materials or proper pretreatment of the coarse cereals only, thus, good mouthfeel is achieved, and the requirement of low GI is met; and GI of a product is less than or equal to 55, and thus, the high-taste-value low-GI formula rice is staple food which can be eaten by diabetes patients at ease.

### DETAILED DESCRIPTION

Preferred examples of the disclosure are illustrated below, and it should be understood that the examples are for better explanation of the disclosure and are not intended to limit the disclosure.

1. Sensory evaluation:

(1) A GB/T 15682-2008 rice and rice cooking edible quality sensory evaluation method table is adopted. 10 sensory evaluation judges from different regions, at different ages and in different genders are selected to evaluate cooked rice processed from the high-taste-value low-GI formula rice, and a sensory evaluation score table is obtained.

TABLE 1
Sensory Evaluation Score Table

| First- | Second- | |
|---|---|---|
| grade | grade | |
| index | index | |
| score | score | Specific description: score |
| Smell | Smell | Having rich and lasting coarse cereal |
| 15 scores | 15 scores | fragrance: 15-12 scores |
| | | Having weak fragrance which is not obvious |
| | | and easy to dissipate: 11-8 scores |
| | | Having no coarse cereal fragrance: 7-5 scores |
| | | Having unpleasant smell: 4-0 scores |
| Appearance | Color | Having moderate color, being glossy to whet the |
| 15 scores | 15 scores | appetite, and being easy to disperse: 15-10 scores |
| | | Having gray color and poor glossiness: 9-5 scores |
| | | Having ugly color and no glossiness: 4-0 scores |
| Palatability | Hardness | Having moderate hardness and good mouthfeel: |
| 30 scores | 10 scores | 10-8 scores; |
| | | Being relatively hard or soft: 7-5 scores; |
| | | Being quite hard or soft: 4-0 scores |
| | Elasticity | Coarse cereal cooked rice has elasticity: 10-8 |
| | 10 scores | scores |
| | | Coarse cereal cooked rice has common |
| | | elasticity: 7-5 scores; |
| | | Coarse cereal cooked rice has no elasticity: |
| | | 4-0 scores |
| | Viscosity | Having viscosity and being clumpy: 10-8 scores; |
| | 10 scores | Having viscosity and loose mouthfeel: 7-5 scores; |
| | | Having no viscosity and being loose: 4-0 scores |

(2) A GB/T 15682-2008 paddy rice and rice cooking edible quality sensory evaluation method table is adopted. 10 sensory evaluation judges from different regions, at different ages and in different genders are selected to eat instant cooked rice processed from the high-taste-value low-GI formula rice which was stored in a refrigerator at the temperature of 4° C. for 14 days and was steamed over water for 10 min, and then evaluate the instant cooked rice processed from the high-taste-value low-GI formula rice, and a sensory evaluation score table 2 is obtained.

TABLE 2
Sensory Evaluation Score Table

| | Second- | |
|---|---|---|
| | grade | |
| First-grade | index | |
| index score | score | Specific description: score |
| Smell | | Having rich and lasting coarse cereal fragrance: |
| 35 scores | | 35-25 scores |
| | | Having weak fragrance which is not obvious |
| | | and easy to dissipate: 24-15 scores |
| | | Having no coarse cereal fragrance: 15-6 scores |
| | | Having unpleasant smell: 5-0 scores |
| Appearance | Color | Having moderate color and being glossy to whet |
| 20 scores | 20 scores | the appetite: 20-12 scores |
| | | Having gray color and poor glossiness: 11-6 |
| | | scores |
| | | Having ugly color and no glossiness: 5-0 scores |
| Palatability | Hardness | Having moderate hardness and good mouthfeel: |
| 45 scores | 15 scores | 15-10 scores; |
| | | Being relatively hard or soft: 9-6 scores; |
| | | Being quite hard or soft: 5-0 scores |
| | Elasticity | Coarse cereal cooked rice has elasticity: |
| | 15 scores | 15-10 scores |
| | | Coarse cereal cooked rice has common |
| | | elasticity: 9-6 scores; |
| | | Coarse cereal cooked rice has no elasticity: |
| | | 5-0 scores |
| | Viscosity | Having viscosity and being clumpy: 15-10 scores; |
| | 15 scores | Having viscosity and loose mouthfeel: 9-6 scores; |
| | | Having no viscosity and being loose: 5-0 scores |

2. A detection method of a GI value is as follows:

The GI value of the instant cooked rice was determined according to the WS/T 652-2019 method published on Jun. 11, 2019 by the National Health Commission.

3. A detection method of hardness, viscosity and elasticity is as follows:

Texture properties of cooked rice were determined by using a TA-XT2i physical property Instrument (SMS, the United Kingdom). During testing, 10 rice grains were randomly selected from different parts of a middle layer of a cooked rice sample every time and were symmetrically placed on an objective table of the physical property instrument for testing, a certain interval is needed between every two rice grains, and each sample is subjected to five times of parallel tests.

4. Low-GI rice A was purchased from Changzhou Wuyu Agricultural Science and Technology Co., Ltd.; low-GI rice B was purchased from Zhejiang Green Biotechnology Co., Ltd.; and low-GI rice C was purchased from Tianmuhu Pharmaceutical Co., Ltd. of Sinopharm Group. Related properties are shown in Table 3.

TABLE 3
GI Values, Edible Quality and Sensory Evaluation
of Different Low-GI Rice

| Sample | Hardness | | | |
|---|---|---|---|---|
| name | g | Viscosity | Elasticity | Mouthfeel and color |
| Rice | 2179 | 30.56 | 0.801 | Moderate hardness, white |
| | | | | color and good mouthfeel |
| Low-GI | 2547 | 22.22 | 0.631 | Relative hard mouthfeel |
| rice A | | | | and relatively yellow color |
| Low-GI | 2536 | 21.66 | 0.655 | Hard mouthfeel, loose rice |
| rice B | | | | grains and no glossiness |
| Low-GI | 2657 | 20.52 | 0.619 | Relatively hard mouthfeel |
| rice C | | | | and uneven cooking degree |
| | | | | of rice grains |

### Example 1: Soaking-Free Coarse Cereals

Selection of a soaking-free coarse cereal raw material is an important factor for improving the taste value, loss of active substances and aromatic substances in a soaking process of coarse cereals before cooking can be avoided, meanwhile, the hardness of the coarse cereals in cooked rice can be reduced and the fragrance of the coarse cereals can be improved through high-temperature fluidization treatment, it is guaranteed that the coarse cereals and the rice can be better fused together due to proper hardness, and the taste value of coarse cereal cooked rice is improved.

The coarse cereals are subjected to high-temperature fluidization treatment to obtain the soaking-free coarse cereals. High-temperature fluidization treatment conditions of the various coarse cereals are as follows: mung beans are subjected to high-temperature fluidization treatment at 180° C., black rice is subjected to high-temperature fluidization treatment at 150° C., then the soaking-free coarse cereals are obtained, and the result is shown in table 4. The hardness of the soaking-free coarse cereals can be greatly reduced after being cooked, the hardness of the black rice before and after fluidization is 2655 g and 1716 g respectively, and the hardness of the mung beans before and after fluidization is 3237 g and 1925 g respectively. Besides, by optimizing the high-temperature fluidization conditions, the high-temperature fluidization conditions of the coarse cereals are as follows: the fluidization temperature of the mung beans is 165-180° C., and the fluidization temperature of the black rice is 145-160° C. The temperature of high-temperature fluidization has a great influence on quality improvement and soaking-free performance of a sample, if the temperature is too high, the sample is prone to scorching, meanwhile, due to the fact that the starch gelatinization degree is increased, the floating probability of the sample in a cooking process is increased, water enters the sample unevenly, and hardness change of the sample is small; and the processing temperature is too low, cracks on the surface of the sample are limited, channels for water to enter the sample are few in the cooking process, permeated water is low, and therefore, the hardness of the sample is limited to be reduced.

TABLE 4
Hardness and Water Absorption of Coarse Cereals Before and After
Soaking-free Treatment

| | Before high-temperature | | After high-temperature | |
|---|---|---|---|---|
| | fluidization treatment | | fluidization treatment | |
| | | Water | | Water |
| | Hardness | absorption | Hardness | absorption |
| Coarse cereals | (g) | (%) | (g) | (%) |
| Mung beans | 3237 | 49.51 | 1925 | 64.43 |
| Black rice | 2655 | 25.51 | 1716 | 32.52 |

### Example 2: Low-GI Instant Cooked Rice

50 g of low-GI rice A, 15 g of mung beans, 12 g of black rice, 8 g of oat milled rice with embryo, 10 g of black sticky rice and 5 g of tartary buckwheat were weighed according to a matching ratio, and were uniformly mixed. Then the mixture was washed, and water was added. The mixture was soaked for 50 min at normal temperature, and was cooked for 40 min under normal temperature. The cooked mixture was added with edible oil, and was packaged into a food-grade packaging material capable of sterilizing under high pressure. The mixture was packaged under vacuum, and sterilization was performed for 30 min under high pressure. Cooling was performed and then the cooled package was taken out to obtain the instant cooked rice processed from the high-taste-value low-GI formula rice.

### Example 3: Low-GI Instant Cooked Rice

50 g of low-GI rice B, 15 g of mung beans, 12 g of black rice, 8 g of oat milled rice with embryo, 10 g of black sticky rice and 5 g of tartary buckwheat were weighed according to a matching ratio, and were mixed uniformly. Then the mixture was washed, and water was added. The mixture was soaked for 50 min at normal temperature, and was cooked for 40 min under normal pressure. The cooked mixture was added with a certain amount of edible oil, and was packaged into a food-grade packaging material capable of sterilizing under high pressure. The mixture was packaged under vacuum, and sterilization was performed for 30 min under high pressure. Cooling was performed and then the cooled package was taken out to obtain the instant cooked rice processed from the high-taste-value low-GI formula rice.

### Example 4: Low-GI Instant Cooked Rice

50 g of low-GI rice C, 15 g of mung beans, 12 g of black rice, 8 g of oat milled rice with embryo, 10 g of black sticky rice and 5 g of tartary buckwheat were weighed according to a matching ratio, and were mixed uniformly. Then the mixture was washed, and water was added. The mixture was soaked for 50 min at normal temperature, and was cooked for 40 min under normal pressure. The cooked mixture was added with edible oil, and was packaged into a food-grade packaging material capable of sterilizing under high pressure. The mixture was packaged under vacuum, and sterilization was performed for 30 min under high pressure. Cooling was performed and then the cooled package was taken out to obtain the instant cooked rice processed from the high-taste-value low-GI formula rice.

### Comparative Example 1: Instant Cooked Rice Processed from Pure Rice

100 g of rice was weighed according to a matching ratio, was washed and then added with water and soaked for 50 min at normal temperature. The rice was cooked for 40 min under normal pressure. The cooked rice was added with edible oil, and was packaged into a food-grade packaging material capable of sterilizing under high pressure. The cooked rice was packaged under vacuum. Sterilization was performed for 30 min under high pressure, cooling was performed, and then the cooled package was taken out to obtain the instant cooked rice processed from rice.

### Comparative Example 2: Instant Cooked Rice Processed from Pure Low-GI Rice

100 g of low-GI rice A was weighed according to a matching ratio, was washed and then added water and soaked for 50 min at normal temperature. The rice was cooked for 40 min under normal pressure. The cooked rice was added with edible oil, and was packaged into a food-grade packaging material capable of sterilizing under high pressure. The cooked rice was packaged under vacuum. Sterilization was performed for 30 min under high pressure, cooling was performed, and then the cooled package was taken out to obtain low-GI instant cooked rice A.

### Comparative Example 3: Instant Cooked Rice Processed from Pure Low-GI Rice

100 g of low-GI rice B was weighed according to a matching ratio, was washed and then added with a certain amount of water and soaked for 50 min at normal temperature. The rice was cooked for 40 min under normal pressure. The cooked rice was added with edible oil, and was packaged into a food-grade packaging material capable of sterilizing under high pressure. The cooked rice was packaged under vacuum. Sterilization was performed for 30 min under high pressure, cooling was performed, and then the cooled package was taken out to obtain low-GI instant cooked rice B.

### Comparative Example 4: Instant Cooked Rice Processed from Pure Low-GI Rice

100 g of low-GI rice C was weighed according to a matching ratio, was washed and then added with a certain amount of water and soaked for 50 min at normal temperature. The rice was cooked for 40 min under normal pressure. The cooked rice was added with edible oil, and was packaged into a food-grade packaging material capable of sterilizing under high pressure. The cooked rice was packaged under vacuum. Sterilization was performed for 30 min under high pressure, cooling was performed, and then the cooled package was taken out to obtain low-GI instant cooked rice C.

### Comparative Example 5: Instant Cooked Rice Processed from Pure Coarse Cereals

15 g of mung beans, 12 g of black rice, 8 g of oat milled rice with embryo, 10 g of black sticky rice and 5 g of tartary buckwheat were weighed according to a matching ratio, were mixed uniformly and then washed, added with water and soaked for 50 min at normal temperature. The mixture was cooked for 40 min under normal pressure. The cooked mixture was added with edible oil, and was packaged into a food-grade packaging material capable of sterilizing under high pressure. The mixture was packaged under vacuum. Sterilization was performed for 30 min under high pressure, cooling was performed and then the cooled package was taken out to obtain instant whole-coarse-cereal cooked rice.

### Comparative Example 6: Instant Cooked Rice Processed from Rice and Coarse Cereals

Compared with example 2, comparative example 6 has the differences as follows: the low-GI rice is replaced with rice, other conditions are the same as those of example 2, and then the instant cooked rice processed from the rice and the coarse cereals is prepared.

50 g of rice, 15 g of mung beans, 12 g of black rice, 8 g of oat milled rice with embryo, 10 g of black sticky rice and 5 g of tartary buckwheat were weighed according to a matching ratio, were mixed uniformly and then washed, added with water and soaked for 50 min at normal temperature. The mixture was cooked for 40 min under normal pressure. The cooked mixture was added with edible oil, and was packaged into a food-grade packaging material capable of sterilizing under high pressure. The cooked mixture was packaged under vacuum. Sterilization was performed for 30 min under high pressure, cooling was performed, and then the cooled package was taken out to obtain the instant cooked rice processed from the rice and the coarse cereals.

TABLE 5
Sensory Evaluation Table of Fresh Samples in Comparative Examples and Examples

| Name | Smell | Appearance | Hardness | Viscosity | Elasticity | Score |
|---|---|---|---|---|---|---|
| Example 2 | 33 | 16 | 13 | 12 | 13 | 87 |
| Example 3 | 34 | 16 | 14 | 13 | 11 | 88 |
| Example 4 | 33 | 15 | 13 | 12 | 13 | 86 |
| Comparative | 15 | 17 | 7 | 10 | 11 | 60 |
| example 1 | | | | | | |
| Comparative | 15 | 11 | 6 | 8 | 6 | 46 |
| example 2 | | | | | | |
| Comparative | 15 | 10 | 7 | 7 | 6 | 45 |
| example 3 | | | | | | |
| Comparative | 15 | 10 | 7 | 8 | 6 | 46 |
| example 4 | | | | | | |
| Comparative | 5 | 9 | 4 | 5 | 6 | 29 |
| example 5 | | | | | | |
| Comparative | 34 | 17 | 13 | 12 | 12 | 88 |
| example 6 | | | | | | |

TABLE 6
Edible Quality of Fresh Samples and Sensory Evaluation Result of Fresh Samples
and Reheated Samples in Comparative Examples and Examples

| | Hardness | | | GI | Sensory evaluation of | Sensory evaluation of |
|---|---|---|---|---|---|---|
| Name | g | Viscosity | Elasticity | value | fresh samples | reheated samples |
| Example 2 | 2137 | 27.15 | 0.821 | 53.14 | Moderate hardness and | Moderate hardness and |
| | | | | | rich coarse cereal | strong coarse cereal |
| | | | | | fragrance | fragrance |
| Example 3 | 2044 | 27.71 | 0.835 | 53.47 | Moderate hardness, | Moderate hardness and |
| | | | | | rich mouthfeel and | attractive color |
| | | | | | layering | |
| Example 4 | 2195 | 25.15 | 0.785 | 52.25 | Moderate hardness, | Relatively high hardness |
| | | | | | easiness in dispersion | and rich mouthfeel |
| | | | | | and good mouthfeel | |
| Comparative | 1879 | 30.56 | 0.801 | 85.17 | Relatively low hardness, | Relatively low hardness, |
| example 1 | | | | | high viscosity and | high viscosity, no rice |
| | | | | | insufficient elasticity | fragrance and hardening |
| Comparative | 2687 | 12.46 | 0.355 | 50.41 | High hardness, no | Poor mouthfeel and |
| example 2 | | | | | viscosity and difficulty | difficulty in eating |
| | | | | | in acceptance | |
| Comparative | 2747 | 13.22 | 0.331 | 51.52 | Poor mouthfeel and | Poor mouthfeel, |
| example 3 | | | | | poor chewing elasticity | relatively high hardness |
| | | | | | | and difficulty in eating |
| Comparative | 2636 | 13.66 | 0.342 | 50.37 | Hard mouthfeel and | Poor mouthfeel, high |
| example 4 | | | | | poor viscosity | hardness and looseness |
| Comparative | 3037 | 5.77 | 0.257 | 45.27 | Difficulty in swallowing | Difficulty in swallowing |
| example 5 | | | | | and relatively high | and high hardness |
| | | | | | hardness | |
| Comparative | 2125 | 26.34 | 0.818 | 65.22 | Good mouthfeel and | Moderate hardness and |
| example 6 | | | | | moderate hardness | slight softness |

By measuring the edible quality of different varieties of low-GI rice and rice, the results in the table 3 show that the hardness of the low-GI rice is obviously higher than that of the rice, and the viscosity and elasticity of the low-GI rice are obviously lower than those of the rice. Cooked rice cooked by the low-GI rice under normal pressure is hard, loose, low in viscosity and yellow in color and is not glossy. In China, the varieties of low-GI rice are few, and three kinds of low-GI rice are screened and collected in the laboratory. The amylose of the low-GI rice is higher than that of daily edible rice, so that the edible quality of the low-GI rice is poorer than that of the rice, and the low-GI rice is mainly expressed in the aspects of hard mouthfeel, light fragrance, low viscosity, easiness in retrogradation and the like. Therefore, although the GI value of the low-GI rice is low, the low-GI rice is relatively low in acceptability when being eaten as staple food alone due to poor mouthfeel. Experimental evaluation shows that the low-GI rice has the characteristic of rapid retrogradation, when the temperature is lower than 58° C., the edible quality of the low-GI rice can be rapidly reduced, and the low-GI rice is difficult to swallow.

Table 5 is about sensory evaluation scores for tastes in the comparative examples and the examples, and results show that the sensory evaluation scores of example 2, example 3 and example 4 are high and are close to the taste score as 88 of comparative example 6. The low-GI rice is used for completely replacing rice to prepare the instant cooked rice processed from the high-taste-value low-GI formula rice, so that the low-GI rice and the coarse cereals achieve a synergistic interaction effect, and obvious effects of improving the hardness, the viscosity, the elasticity and the like of the sample are achieved. Compared with instant cooked rice prepared from rice, the instant cooked rice processed from the high-taste-value low-GI formula rice has rich coarse cereal fragrance and richer mouthfeel; the instant cooked rice processed from the high-taste-value low-GI formula rice is moderate in viscosity, but cooked rice is high in viscosity, is soft when being eaten and is difficult to disperse; the instant cooked rice cooked from rice is obviously insufficient in elasticity and high in water content and does not have chewiness, and the taste score is 60 and is obviously lower than that of the instant cooked rice processed from the high-taste-value low-GI formula rice. The instant cooked rice purely prepared from the low-GI rice is difficult to swallow, too high in hardness, loose, strong in granular sensation, poor in palatability and inelastic. The whole-coarse-cereal instant cooked rice prepared from whole coarse cereals is high in hardness, free of viscosity, extremely poor in palatability and difficult to swallow, and the sensory evaluation score of the whole-coarse-cereal instant cooked rice is only 29 and is obviously different from that of the examples.

Table 6 is determination of GI and edible quality in the examples and the comparative examples, and evaluation comparison of sensations of fresh processed samples and reheated samples stored in accelerated retrogradation. The hardness, viscosity and elasticity in example 2, example 3 and example 4 are close to the edible quality of rice and coarse cereal instant cooked rice prepared from rice and coarse cereals, but the GI is between 52.25 and 53.47 and is obviously lower than that in comparative example 6, the GI value of the instant cooked rice prepared from the rice and the coarse cereals is 65.22, according to the standard of GI values for high-GI food, medium-GI food and low-GI food, the GI value in comparative example 6 is obviously greater than 55, and the cooked rice in comparative example 6 is not low-GI food. Compared with instant cooked rice processed from rice, the instant cooked rice processed from the high-taste-value low-GI formula rice has the advantages that the GI is reduced by 37.6% compared with the rice, the instant cooked rice processed from the high-taste-value low-GI formula rice has better hardness, viscosity and elasticity, accelerated retrogradation treatment is achieved, the reheated instant cooked rice processed from rice is free of rice fragrance, soft, hardened and poor in palatability, and the mouthfeel of the reheated instant cooked rice processed from the high-taste-value low-GI formula rice is almost the same as that of the freshly prepared sample. By matching of the low-GI rice and the coarse cereals, defects of high hardness, insufficient viscosity and the like of two kinds of raw materials are overcome, and moreover, an additive synergistic effect is also achieved in the aspects of inhibition of starch retrogradation of the low-GI rice and retaining the coarse cereal fragrance. It can also be seen from comparative example 2, comparative example 3, comparative example 4 and comparative example 5 that the low-GI rice and the pure coarse cereal raw material are prepared into the low-GI instant cooked rice and the coarse cereal instant cooked rice respectively, and evaluation results of high hardness, low viscosity, insufficient elasticity, poor palatability and difficulty in swallowing are obtained.

The low-GI rice replaces rice, the GI value of the sample is reduced, and moreover, an effect of improving the edible quality of low-GI coarse cereals is also achieved. According to an early-stage test of the experimental group, the texture of the low-GI rice is hard, the water absorption rate of the low-GI rice is close to that of fluidized coarse cereals, under the same condition, the water absorption rate of the low-GI rice is close to that of the coarse cereals, the curing degree of the low-GI rice is also close to that of the coarse cereals, and difference such as non-uniform mouthfeel is avoided; and lots of coarse cereals are rich in phytochemicals, and through reasonable matching, starch retrogradation in the low-GI rice is inhibited well. In a starch retrogradation acceleration test, the mouthfeel of the reheated instant cooked rice processed from the high-taste-value low-GI formula rice is not obviously different from that of a freshly prepared sample, and the coarse cereal fragrance is strong. The edible quality and sensory evaluation comparison after reheating of the data in table 6 and scores of sensory evaluation in table 5 have a mutual confirmation effect, it proves that preparation of the instant cooked rice processed from the high-taste-value low-GI formula rice by completely replacing the rice with the low GI rice is completely feasible.

### Example 5: Cooked Rice Processed from Low-GI Formula Rice

35 g of low-GI rice A, 15 g of rice, 20 g of mung beans, 10 g of black rice, 10 g of oat milled rice with embryo, 5 g of black sticky rice and 5 g of tartary buckwheat were weighed according to a matching ratio and were mixed uniformly; then the mixture was placed in a household electric cooker, was washed and then added with water, and was cooked for 35 min under normal pressure; and the cooked mixture was insulated for 20 min for eating.

### Example 6: Cooked Rice Processed from Low-GI Formula Rice

35 g of low-GI rice B, 15 g of rice, 20 g of mung beans, 10 g of black rice, 10 g of oat milled rice with embryo, 5 g of black sticky rice and 5 g of tartary buckwheat were weighed according to a matching ratio and were mixed uniformly; then the mixture was placed in a household electric cooker, was washed and then added with water, and was cooked for 35 min under normal pressure; and the cooked mixture was insulated for 20 min for eating.

### Example 7: Cooked Rice Processed from Low-GI Formula Rice

35 g of low-GI rice C, 15 g of rice, 20 g of mung beans, 10 g of black rice, 10 g of oat milled rice with embryo, 5 g of black sticky rice and 5 g of tartary buckwheat were weighed according to a matching ratio and were mixed uniformly; then the mixture was placed in a household electric cooker, was washed and then added with water, and was cooked for 35 min under normal pressure; and the cooked mixture was insulated for 20 min for eating.

### Comparative Example 7: Pure Rice

100 g of rice was weighed, was placed in a household electric cooker, was washed and then added with a certain amount of water, and was cooked for 35 min under normal pressure; and the cooked rice was insulated for 20 min for eating.

### Comparative Example 8: Cooked Rice Processed from Raw Materials without Rice

50 g of low-GI rice A, 20 g of mung beans, 10 g of black rice, 10 g of oat milled rice with embryo, 5 g of black sticky rice and 5 g of tartary buckwheat were weighed and were mixed uniformly; then the mixture was placed in a household electric cooker, was washed and then added with water, and was cooked for 35 min under normal pressure; and the cooked rice was insulated for 20 min for eating.

### Comparative Example 9: Cooked Rice Processed from Raw Materials without Low-GI Rice

50 g of rice, 20 g of mung beans, 10 g of black rice, 10 g of oat milled rice with embryo, 5 g of black sticky rice and 5 g of tartary buckwheat were weighed and were mixed uniformly; then the mixture was placed in a household electric cooker, was washed and then added with water, and was cooked for 35 min under normal pressure; and the cooked rice was insulated for 20 min for eating.

### Comparative Example 10: Pure Coarse Cereal Rice

20 g of mung beans, 10 g of black rice, 10 g of oat milled rice with embryo, 5 g of black sticky rice and 5 g of tartary buckwheat were weighed and were mixed uniformly; then the mixture was placed in a household electric cooker, was washed and then added with water, and was cooked for 35 min under normal pressure; and the cooked rice was insulated for 20 min for eating.

TABLE 7
Sensory Evaluation Table for Comparative Examples and Examples

| | | | | | | Taste | |
|---|---|---|---|---|---|---|---|
| Name | Appearance | Color | Hardness | Elasticity | Viscosity | store | Sensory evaluation |
| Example 5 | 14 | 14 | 9 | 9 | 9 | 55 | Moderate hardness, |
| | | | | | | | rich mouthfeel and |
| | | | | | | | attractive color |
| Example 6 | 15 | 14 | 9 | 9 | 9 | 56 | Moderate hardness, |
| | | | | | | | uniform cooked rice |
| | | | | | | | and layered mouthfeel |
| Example 7 | 14 | 15 | 9 | 9 | 9 | 56 | Moderate hardness, |
| | | | | | | | attractive color and |
| | | | | | | | chewiness |
| Comparative | 15 | 14 | 9 | 9 | 9 | 56 | Moderate hardness, |
| example 7 | | | | | | | monotonous |
| | | | | | | | mouthfeel and high GI |
| Comparative | 8 | 8 | 4 | 4 | 4 | 32 | Relatively high |
| example 8 | | | | | | | hardness, poor |
| | | | | | | | viscosity and |
| | | | | | | | non-uniform cooking |
| | | | | | | | degree of cooked rice |
| Comparative | 15 | 14 | 9 | 9 | 9 | 55 | Moderate hardness, |
| example 9 | | | | | | | good mouthfeel and |
| | | | | | | | medium GI |
| Comparative | 8 | 7 | 3 | 4 | 3 | 26 | Relatively high |
| example 10 | | | | | | | hardness, rough |
| | | | | | | | mouthfeel and poor |
| | | | | | | | taste |

TABLE 8
Edible Quality and Sensory Evaluation Results of Comparative
Examples and Examples

| Name | Hardness g | Viscosity | Elasticity | GI value |
|---|---|---|---|---|
| Example 5 | 2153 | 16.12 | 0.851 | 53.14 |
| Example 6 | 2117 | 16.71 | 0.854 | 53.54 |
| Example 7 | 2195 | 16.15 | 0.865 | 54.27 |
| Comparative | 1879 | 18.56 | 0.841 | 89.97 |
| example 7 | | | | |
| Comparative | 2342 | 13.47 | 0.824 | 55.21 |
| example 8 | | | | |
| Comparative | 2230 | 17.34 | 0.733 | 65.41 |
| example 9 | | | | |
| Comparative | 2894 | 9.45 | 0.511 | 50.31 |
| example 10 | | | | |

According to the technology, three kinds of screened rice are all low-GI rice. The GI values of the three kinds of screened rice are all smaller than 55 through detection. However, due to the fact that the mouthfeel, viscosity and elasticity of the three kinds of screened rice are insufficient, the three kinds of screened rice need to be matched with appropriate rice to achieve the purposes of increasing the viscosity of the low-GI formula rice, neutralizing the hardness of the low-GI rice and improving elasticity. The low-GI rice and the rice are matched, and proper coarse cereals are added, so that the GI value of the cooked rice processed from the low-GI formula rice is lower than 55 and reaches the standard of low-GI food. The obtained cooked rice processed from the high-taste-value low-GI formula rice is rich in mouthfeel, moderate in hardness, appropriate in viscosity and attractive in color. In the raw materials of the cooked rice processed from the high-taste-value low-GI formula rice, the low-GI rice, the mung beans and the tartary buckwheat are all low-GI food, and the oat milled rice with embryo is medium-GI food. Therefore, the GI of the sample can be reduced to 55 or below by blending different raw materials. By adding 50% of coarse cereals, the GI value of the cooked rice can be obviously reduced, the mouthfeel of the cooked rice can be improved, the viscosity of the cooked rice processed from the low-GI formula rice can be reduced, special coarse cereal fragrance is achieved, the mouthfeel of the cooked rice processed from the low-GI formula rice is enriched, release of blood glucose can be obviously delayed after eating, the area under the curve of blood glucose can be controlled, and therefore, the purpose of reducing the blood glucose index is achieved. Due to the variety difference between the low-GI rice and the slight difference of basic components, the low-GI rice shows different properties. According to the characteristics of the low-GI rice, the low-GI rice is matched with common rice and coarse cereals, the advantages are complemented, the GI value, hardness, viscosity and elasticity of the sample serve as reference indexes, and the optimal combination formula is screened out in combination with sensory evaluation by taking the index of the cooked rice as a reference value.

Results in table 7 and table 8 show that after different varieties of low-GI rice are matched with rice and the three kinds of low-GI rice in the examples are compounded with the rice, the coarse cereals such as low-GI tartary buckwheat and low-GI mung beans are added to prepare the cooked rice processed from the high-taste-value low-GI formula rice, and the taste score of the cooked rice processed from the high-taste-value low-GI formula rice is not obviously different from the taste score of the cooked rice. Through detection and comparison, the hardness of the cooked rice processed from the low-GI formula rice can be obviously reduced by adopting a technology of mutual matching of the rice and the low-GI rice, and meanwhile, the coarse cereals can be cooked together with the rice without soaking due to that the coarse cereals have been subjected to fluidization treatment. Researches show that the cooking hardness of the coarse cereals subjected to fluidization treatment is also obviously reduced. Although the hardness of the instant cooked rice in the examples is slightly higher than that of the cooked rice, the difference is not obvious, sensory evaluation results also show that the mouthfeel difference is small. The cooked rice processed from the high-taste-value low-GI formula rice is uniform in appearance, attractive in color, moderate in hardness and close to rice in mouthfeel, has a layering sense compared with the rice, has a coarse cereal fragrance, and has GI obviously lower than that of the rice.

The hardness of the edible quality in example 5, example 6 and example 7 is close to the hardness in comparative example 7, is slightly higher than the hardness of the cooked rice, and is acceptable, dispersity is better, viscosity is low, the elasticity is better than that of the cooked rice in comparative example 7, and the cooked rice in example 5, example 6 and example 7 has chewiness. The GI value of the low-GI formula rice prepared like this is between 53.14 and 54.27, is reduced by about 40% compared with that of the GI (89.97) of the rice in comparative example 7, and thus, the low-GI formula rice is low-GI food.

The rice is removed in comparative example 8, the low-GI rice and coarse cereals are matched with each other, the GI can be remarkably reduced, the low-GI requirement is met, but the taste score of the cooked rice in comparative example 8 is lower than the taste scores of the cooked rice in example 5, example 6 and example 7, the low-GI rice is independently applied to the cooked rice processed from the low-GI formula rice, only the GI value of the cooked rice processed from the low-GI formula rice is reduced, and palatability is not obviously improved. Therefore, by a proper ratio of the rice to the low-GI rice, the effect of application of the low-GI rice in the low-GI formula rice can be improved in an assisted manner, and an effect of improving the appearance, color, hardness, viscosity and elasticity of the cooked rice processed from the low-GI formula rice is obvious.

Compared with example 5, example 6 and example 7, comparative example 9 has the low-GI rice removed, the taste score of the cooked rice in comparative example 9 is close to that of the cooked rice in comparative example 7, the mouthfeel is rich, and the GI value of the cooked rice in comparative example 9 is 65.41 through detection and does not meet the standard of low-GI food.

In comparative example 10, the low-GI rice and the rice are removed, the coarse cereals are compounded according to the original ratio and cooked, the GI value is greatly reduced, but the palatability is poor, the hardness reaches 2894 g, the viscosity is poor, the elasticity is insufficient, and the coarse cereals cannot be normally eaten. The taste score is 26 and is obviously lower than that of the cooked rice in example 5, example 6 and example 7. Therefore, through reasonable matching of the low-GI rice and the rice, 50% of appropriate coarse cereals are added and matched according to the ratio of 1:1 to obtain the high-taste-value low-GI formula rice, the content of the GI value can be neutralized, furthermore, an effect of improving the viscosity and elasticity of the low-GI formula rice can be achieved, the mouthfeel can be enriched, and the color of the low-GI coarse cereals can be improved.

The cooking mode of the high-taste-value low-GI formula rice is a mode of cooking the high-taste-value low-GI formula rice in a household electric cooker under normal pressure, and the coarse cereals are kept in a natural form; the coarse cereals do not need to be soaked in advance, thus, the time is saved, and loss of active substances during soaking of the coarse cereals is reduced. The low-GI formula rice disclosed by the disclosure has the characteristics of good mouthfeel, low GI and easiness in cooking, and meets the daily life requirements of people needing to eat low-GI staple food.

Although the disclosure has been described with reference to the preferred examples, it is not intended to limit the disclosure, various changes and modifications can be made therein by one skilled in the art without departing from the spirit and scope of the disclosure, and the scope of protection of the disclosure should be defined by the claims.

What is claimed is:

1. High-taste-value low-glycemic-index (low-GI) formula rice, comprising low-GI rice and coarse cereals with a mass ratio of the low-GI rice to the coarse cereals of 1:(0.8-1.2), or comprising low-GI rice, non-low-GI rice and coarse cereals with a mass ratio of the low-GI rice to the non-low-GI rice to the coarse cereals is (1-4):(1-4): 5.

2. The high-taste-value low-GI formula rice according to claim 1, wherein the low-GI rice has hardness of 2000-2700 g, viscosity of 20-25, and elasticity of 0.6-0.8.

3. The high-taste-value low-GI formula rice according to claim 1, wherein the coarse cereals comprise one or more of mung beans, black rice, oat milled rice with embryo, black sticky rice and tartary buckwheat.

4. The high-taste-value low-GI formula rice according to claim 3, wherein the coarse cereals comprise 15-25 parts of the mung beans, 8-15 parts of the black rice, 10-15 parts of the oat milled rice with embryo, 5-10 parts of the black sticky rice and 3-10 parts of the tartary buckwheat.

5. The high-taste-value low-GI formula rice according to claim 4, wherein the mung beans are obtained by a high-temperature fluidization treatment at 165-180° C. for 30-60 s.

6. The high-taste-value low-GI formula rice according to claim 4, wherein the black rice is obtained by a high-temperature fluidization treatment at 145-160° C. for 30-60 s.

7. A method of preparing high-taste-value low-GI formula cooked rice, comprising: taking the high-taste-value low-GI formula rice according to claim 1 as a raw material, placing the high-taste-value low-GI formula rice in a household electric cooker, washing the rice, then adding water, cooking the rice for 30-40 min under a normal pressure, and then insulating the cooked rice for 20-30 min.

8. The method according to claim 7, comprising: weighing 35 g of low-GI rice, 15 g of non-low-GI rice, 20 g of fluidized mung beans, 10 g of fluidized black rice, 10 g of oat milled rice with embryo, 5 g of black sticky rice and 5 g of tartary buckwheat, uniformly mixing the raw materials, then placing the mixture into a household electric cooker, washing the mixture, then adding water into the mixture, cooking the mixture for 35 min under a normal pressure, and insulating the cooked rice for 20 min for eating, wherein the fluidized mung beans are obtained by a fluidization treatment at 180° C. for 55 s; and the fluidized black rice is obtained by a fluidization treatment at 150° C. for 55 s.

9. A method of preparing high-taste-value low-GI instant cooked rice, comprising: taking the high-taste-value low-GI formula rice according to claim 1 as a raw material, washing the rice, then adding water for soaking for 40-60 min, cooking the rice for 30-40 min under a normal pressure, adding edible oil, packaging the cooked rice into a food-grade packaging material capable of sterilizing under a high pressure, performing sterilization for 20-30 min under a high pressure, performing cooling, and then taking out the cooked rice so as to obtain the instant cooked rice processed from the high-taste-value low-GI formula rice.

10. The method according to claim 9, comprising: weighing 50 g of low-GI rice, 15 g of fluidized mung beans, 12 g of fluidized black rice, 8 g of oat milled rice with embryo, 10 g of black sticky rice and 5 g of tartary buckwheat, uniformly mixing the raw materials, then washing the mixture, adding water into the mixture for soaking the mixture at a normal temperature for 50 min, cooking the mixture under a normal pressure for 40 min, adding edible oil, packaging the cooked rice into a food-grade packaging material capable of sterilizing under a high pressure, packaging the cooked rice under vacuum, performing sterilization for 30 min under a high pressure, performing cooling, and then taking out the cooked rice to obtain the instant cooked rice processed from the high-taste-value low-GI formula rice, wherein the fluidized mung beans are obtained by a fluidization treatment at 180° C. for 55 s; and the fluidized black rice is obtained by a fluidization treatment at 150° C. for 55 s.
